(19) United States
(12) Patent Application Publication
(10) Pub. No.: US 2024/0228742 A1
(43) Pub. Date: Jul. 11, 2024

(54) POLYMER COMPOSITION HAVING FLAME RETARDANT PROPERTIES

(71) Applicant: NUOVA SIMA S.R.L., Genga (AN) (IT)

(72) Inventors: Diego TIRELLI, Sesto San Giovanni (MI) (IT); Lucia CAMPANELLI, Santa Maria Nuova (AN) (IT); Fabio CASTELLANI, Fabriano (AN) (IT)

(73) Assignee: NUOVA SIMA S.R.L., Genga (AN) (IT)

(21) Appl. No.: 18/559,946

(22) PCT Filed: May 17, 2022
(86) PCT No.: PCT/IB2022/054560

§ 371 Date: Nov. 9, 2023

(30) Foreign Application Priority Data
May 18, 2021 (IT) 102021000012788

(51) Int. Cl. C08K 3/22; C08K 9/04; C08L 23/06; C08L 23/08; C08L 23/16

(52) U.S. Cl. CPC C08K 3/22; C08K 9/04; C08L 23/06; C08L 23/0815; C08L 23/0853; C08L 23/0869; C08L 23/16; C08K 2003/2227; C08K 2201/005; C08K 2201/006; C08L 2201/02; C08L 2207/04; C08L 2207/062; C08L 2207/064; C08L 2207/066

(57) ABSTRACT

A composition having flame retardant properties comprising a polymeric material and a bauxite as flame retardant filler dispersed in the polymeric material, wherein the bauxite has an aluminum hydroxide content of at least 50% by weight and is in the form of particles having an average size (d₅₀) not higher than 8.0 μm and a specific surface area (BET) not higher than 10.0 m²/g. These compositions provide excellent performance in terms of both self-extinguishing and mechanical properties, in particular elongation at break. Such compositions may be used to produce cable jackets for the transport or distribution of electrical energy and/or for telecommunications, panels and coverings for buildings, pipes, and the like.

### CROSS REFERENCE TO RELATED APPLICATIONS

This application is a National Stage entry under 35 U.S.C. § 371 of PCT/IB2022/054560, filed on May 17, 2022, and claims priority to IT Patent Application No. 102021000012788, filed on May 18, 2021, the entire contents of which are incorporated herein by reference.

The present invention relates to a polymeric composition having flame retardant properties. In particular, the present invention relates to a polymeric composition having flame retardant properties containing a bauxite as a flame retardant filler.

The use of flame retardant products in mixtures and composites based on polymeric materials (thermoplastic, thermosetting or elastomeric) has been widely established in industrial practice over the last few decades, in order to impart flame retardant properties to the material and thus ensure compliance with Italian, European and international regulations on safety in the event of fire in public and private buildings.

Over the years, these regulations have become more and more stringent with regard to the capability of the products of various kind (cables for energy transport and telecommunications, panels and coverings for buildings, pipes and other products) to self-extinguish if they are hit by flames, not to spread the fire further and not to develop opaque smokes and toxic, irritating or corrosive gases during combustion.

The flame retardant products used today are generally divided into two categories: halogenated products and non-halogenated products.

Halogenated products (e.g. organic compounds containing chlorine and/or bromine) are very effective even when added to the polymeric material in small quantities, but they present toxicity problems both during the production step of mixtures and composites and during combustion due to a possible fire. In fact, when the product is subjected to combustion, it emits toxic, irritating or corrosive substances, as well as increasing the emission of opaque smokes, which limit visibility of escape routes during emergency evacuation required in the event of a fire inside buildings.

Non-halogenated products are usually metal hydroxides, such as aluminum hydroxides, magnesium hydroxides, or organic and inorganic compounds containing nitrogen and/or phosphorus. They are less effective than halogenated products, thus a larger quantity of the same must be introduced into the polymeric material to achieve satisfactory flame retardant properties, but they have clear advantages in terms of lower toxicity. Among them, aluminum hydroxide and magnesium hydroxide are the preferred ones, where applicable, as they are inherently safe and do not generate toxic products during combustion (they emit only water steam), reducing or eliminating emission of opaque smokes.

Since 1 Jul. 2017, a new European regulation (CPR—Construction Product Regulation) has entered into force that regulates, in all European Union countries, the way in which a construction product is placed on the market, harmonising methods, declaration of performance and related quality control systems. The CPR also specifies the performance, in terms of reaction to fire on the basis of specific test methods, that all products used in construction must possess. In particular, the products are divided into classes of reaction to fire on the basis of some parameters relating to the emission of heat (in particular heat emission rate and total emitted heat) and the emission of smokes (in particular smoke emission rate, total emitted smokes, and acidity and toxicity of the same).

In order to achieve fire performance typical of the highest classes, it is necessary to use remarkable quantities of fire retardant filler, in particular aluminum hydroxide and/or magnesium hydroxide, in the polymer-based mixtures and composites. This need may lead to a significant deterioration of other properties of the polymeric material, especially with regard to mechanical, electrical and rheological properties.

Aluminum hydroxide (Aluminium TriHydrate ATH) is the most widely used material as a flame retardant filler in polymeric materials. ATH for this purpose is usually produced starting from bauxite by a chemical process called Bayer process. Bauxite is a rock generally consisting mostly of aluminum hydroxide (gibbsite ore) and aluminum oxo-hydroxide (boehmite ore), with a variable content of oxides and oxo-hydroxides of silicon, iron, titanium and other metals.

The Bayer process requires a huge consumption of water and energy and is carried out in several successive steps. Initially, bauxite is crushed and dissolved in caustic soda at high temperatures to generate a solution containing sodium aluminate and other insoluble impurities. The amount and type of these impurities vary depending on the composition of the bauxite used.

Impurities generally consist of oxides and/or oxo-hydroxides of silicon, iron, titanium and other metals. These products, which are not soluble in the soda solution, must be filtered out and discarded as solid residues, which will constitute the so-called “red mud”. This by-product presents considerable disposal problems, mainly due to its strong basicity (its pH can vary from 10 to 13). In most cases, in fact, it has to be pumped into appropriate settling and storage basins, with no possibility of recovery or disposal.

The sodium aluminate solution is then cooled, allowing the aluminum hydroxide to precipitate as a finely divided white solid (from which the aqueous solution must be removed by filtration), which is then subjected to a drying process.

The resulting ATH typically has a purity greater than 99% and a d₅₀ value typically in the range of 50 to 200 μm. However, this particle size is not yet adequate for most of the applications mentioned above, and therefore requires further reduction. To carry out this refinement, a second dissolution in soda is carried out in order to re-precipitate the ATH under controlled conditions that allow to reach the desired particle size and to further purify the material. This step requires a further substantial consumption of water and energy (necessary for the second drying of the material).

Alternatively, it is possible to operate using exclusively mechanical processes, i.e. grinding the ATH deriving from the Bayer process in suitable mills, until the desired particle size is obtained. However, the ATHs obtained by grinding exhibit different properties than the ATHs obtained by re-precipitation. In particular, the ground ATHs have a much higher surface area and moisture content when compared to re-precipitated ATHs having a similar particle size distribution. These properties adversely affect the performance of the mixtures in which they are used. Typically, the ground ATHs gives the polymeric mixtures a much lower elongation at break, a higher viscosity and a greater tendency to moisture absorption.

The moisture absorbed by the mixtures can cause further problems during their processing. For example, in the case of extrusion processes (such as those required for cable production) the moisture contained can be released in the form of steam during the process, generating diffuse porosities in the polymeric mixture and poor surface finishing of the same.

A further alternative is the use of bauxite as a flame retardant, without subjecting it to the Bayer purification process. In this case, only the ore is mechanically ground in order to obtain the desired particle size. However, if the aluminum hydroxide content of the bauxite used is not sufficiently high, the flame retardant properties of these products are significantly lower than those of the products obtained by the Bayer process.

U.S. Pat. No. 4,216,130 describes the use of ground bauxite for the production of aqueous suspensions of natural or synthetic rubber latexes for the carpet industry. Ground bauxite is characterised by a surface area of less than 12 m²/g, a pH value in the aqueous suspension higher than 6.5 and a particle size distribution such that more than 15% by weight of the particles have a size of less than 3 μm.

U.S. Pat. No. 6,252,173 describes the use of bauxite, in particular bauxite with a high alumina content, or of brucite as flame retardant fillers in non-aqueous organic polymeric formulations, particularly suitable for making insulation layers and sheaths for electrical cables and for telecommunications, as a substitute for ATH. Bauxite or brucite particles preferably have an average size (d₅₀) of 0.3 to 5.0 μm and a surface area greater than 10 m²/g. In the working examples, three different bauxites with different geographical origins are used, characterized respectively by a d₅₀ value equal to 18.1 μm, 18.8 μm or 13.94 μm and a surface area value equal to 12.4 m²/g, 12.1 m²/g or 8.75 m²/g.

The Applicant has found that, as already indicated above, flame retardant regulations for cables and building materials have become increasingly stringent in recent decades. It is therefore necessary to use a high quantity of flame retardant filler to meet the requirements in terms of the flame retardancy of the mixtures. This necessity, as highlighted, imposes a very careful selection of characteristics for the flame retardant fillers in order to guarantee that the requirements of flame retardant regulations are met, while at the same time not affecting the other properties of the material (mechanical, electrical and rheological).

In this regard, the Applicant has found that the bauxites suggested by the prior art, in particular those disclosed in patents U.S. Pat. Nos. 4,216,130 and 6,252,173 referred to above, do not possess the adequate characteristics to satisfy such requirements, since, especially when used in high quantities (generally higher than 100 phr, i.e. parts by weight per 100 parts by weight of polymeric base) in order to achieve the desired flame retardant performance, they significantly worsen the tensile mechanical properties (in particular the values of elongation at break), even in the presence of compatibilizing additives (such as ethylene/maleic anhydride copolymers or the like) commonly used in this type of mixtures to improve compatibility between the polymeric base and the flame retardant filler.

The Applicant has found that bauxites characterised by an aluminum hydroxide content equal to at least 50% by weight, in the form of particles having an average size (d₅₀) not higher than 8.0 μm and a specific surface area (BET) not higher than 10.0 m²/g, can be used as a flame retardant filler in polymeric materials and provide excellent performance in terms of both self-extinguishing and mechanical properties, in particular elongation at break, fully comparable to those obtainable with an ATH produced by the Bayer process and subsequent re-precipitation.

According to a first aspect, the present invention therefore relates to a composition having flame retardant properties comprising a polymeric material and a bauxite as flame retardant filler dispersed in the polymeric material, wherein the bauxite has an aluminum hydroxide content of at least 50% by weight and is in the form of particles having an average size (d₅₀) not higher than 8.0 μm and a specific surface area (BET) not higher than 10.0 m²/g.

For the purposes of the present invention, in the following description and claims, the definitions of numerical ranges comprise the individual values within the range and its extremes, unless otherwise specified.

For the purposes of the present description and the following claims, the term “comprising” also includes the terms “which essentially consists of” or “which consists of”.

Preferably, the bauxite is present in the polymeric material in an amount of at least 100 parts by weight with respect to 100 parts by weight of polymeric material (phr), more preferably at least 120 phr. Preferably, this amount is not higher than 280 phr, more preferably not higher than 220 phr.

Preferably, the bauxite is in the form of particles having an average size (d₅₀) not higher than 6.0 μm, even more preferably not higher than 4.0 μm. Preferably, the average size (d₅₀) is at least equal to 0.5 μm, even more preferably at least equal to 1.0 μm.

Preferably, the bauxite is in the form of particles having a specific surface area (BET) not higher than 9.0 m²/g, even more preferably not higher than 8.0 m²/g. Preferably, the specific surface area (BET) is at least equal to 2.0 m²/g, even more preferably at least equal to 4.0 m²/g.

The particle size distribution of bauxite and thus the d₅₀ value, i.e. the diameter value below which 50% by weight of the particle population is found (median value), can be determined by means of a gravity sedimentation technique with X-ray absorption according to the standard ISO 13317-3:2001. For this purpose, the Sedigraph III Plus device from Micromeritics can be used (see the manual available at:
https://www.micromeritics.com/Repository/Files/Sed iGraph_III_5120_Operator_Manual_Rev_K_Nov_2018.pdf).

Alternatively, the particle size distribution can be determined by laser diffraction technique according to the standard ISO 13320:2009. See also “A Guidebook to Particle Size Analysis” published by Horiba Instruments Inc.—2016, available at:
https://www.horiba.com/fileadmin/uploads/Scientific/eMa g/PSA/Guidebook/pdf/PSA_Guidebook.pdf).

The specific surface area (BET) of bauxite can be measured according to the standard ISO 9277-2010.

Preferably, the bauxite has an aluminum hydroxide content of at least 70% by weight, more preferably at least 90% by weight. The term “aluminum hydroxide” refers to both the actual aluminum hydroxide (Al(OH)₃) (i.e. gibbsite) and the aluminum oxo-hydroxides (i.e. boehmite). The remaining part of the bauxite typically consists of oxides and oxo-hydroxides of silicon, iron, titanium and/or other metals.

Bauxite in accordance with the present invention can be obtained by crushing and subsequent grinding of the ore in accordance with known techniques. Grinding can be carried out, wet or dry, by means of mills with controlled particle size, equipped with a particle size selector. The mills can be of different types, such as: ball mills, track and roller mills, impact mills, air-jet mills. Grinding may be carried out if necessary in the presence of a grinding aid, for example a polyglycol.

The bauxite particles may be used as such, or they can be pre-treated on the surface with at least one coupling agent, which promotes compatibility with the polymeric material. The coupling agent is preferably a saturated or unsaturated fatty acid, containing from 8 to 24 carbon atoms, or a derivative thereof, in particular a salt, an anhydride or an ester. The fatty acid may be, for example, oleic acid, palmitic acid, stearic acid, isostearic acid, lauric acid, magnesium or zinc oleate or stearate, or mixtures thereof. The coupling agent may also be selected from organic silanes or titanates, such as for example: vinyltriethoxysilane, vinyltriacetylsilane, tetra-isopropyltitanate, tetra-n-butyltitanate, and mixtures thereof.

With regard to the polymeric material, this can be selected from a wide range of products depending on the specific application to which the composition according to the invention is intended.

Preferably, the polymeric material is a polyolefin, in particular a polyethylene or a polypropylene, or mixtures thereof.

The polyethylene may be an ethylene homopolymer or a copolymer of ethylene with at least one C₃-C₁₂ alpha-olefin, having a density from 0.910 to 0.970 g/cm³, preferably from 0.915 to 0.940 g/cm³. This class of materials include: high density polyethylene (HDPE), medium density polyethylene (MDPE), low density polyethylene (LDPE) and linear low density polyethylene (LLDPE). These are usually obtained by Ziegler-Natta catalysis.

Another class of polyethylenes are those with very low density (VLDPE) having a density from 0.870 to 0.910 g/cm³, preferably from 0.880 to 0.905 g/cm³. These are copolymers of ethylene with at least one C₃-C₁₂, preferably C₆-C₁₀ alpha-olefin, obtained by metallocene or single-site catalysts.

“C₃-C₁₂ alpha-olefin” means an olefin of formula CH₂═CH—R, wherein R is a linear or branched alkyl having from 1 to 10 carbon atoms. Preferably, the alpha-olefin is a C₄-C₈ alpha-olefin. Preferably this is selected from: 1-butene, 1-pentene, 4-methyl-1-pentene, 1-hexene, 1-octene, 1-dodecene.

Another class of polyethylenes are copolymers of ethylene with at least one ester having an ethylene unsaturation. The ester is preferably selected from: C₁-C₈ alkylacrylates, C₁-C₈ alkylmethacrylates, vinyl C₂-C₈ carboxylates. The amount of ester comonomer in the copolymer is generally from 5% to 50% by weight, preferably from 15% to 40% by weight. Examples of C₁-C₈ alkylacrylates or alkylmethacrylates are: ethylacrylate, methylacrylate, methylmethacrylate, tert-butylacrylate, n-butylmethacrylate, 2-ethylhexylmethacrylate, and the like. Examples of vinyl C₂-C₈ carboxylates are: vinylacetate, vinylpropionate, vinylbutanoate, and the like. Particularly preferred are ethylene-vinylacetate (EVA) and ethylene-n-butylacrylate (EBA) copolymers.

Another class of polyolefins are ethylene/propylene copolymers comprising from 5 to 25% by weight of ethylene, from 75 to 95% by weight of propylene, and optionally an amount not higher than 10% in weight of a diene. Suitable dienes such as possible termonomers are selected for example from: 1,4-hexadiene, 1,6-octadiene, 5-methyl-1,4-hexadiene, 3,7-dimethyl-1,6-octadiene, dicyclopentadiene (DCPD), ethylidene norbornene (ENB), or mixtures thereof.

Polypropylene may be a propylene homopolymer or a propylene copolymer with at least one olefinic comonomer selected from ethylene and an alpha-olefin other than propylene. The amount of olefinic comonomer is usually less than or equal to 15% in moles. The melting point of polypropylene is typically greater than or equal to 120° C. and the melting enthalpy is typically from 20 J/g to 120 J/g. In the case of propylene copolymers, these can in particular be selected from heterophasic copolymers consisting of a propylene-based thermoplastic phase in which an elastomeric phase based on ethylene copolymerized with an alpha-olefin, preferably with propylene, is dispersed. Preferably, the elastomeric phase is present in an amount not less than 40% by weight with respect to the total weight of the heterophasic copolymer.

Alternatively, halogenated polymers, in particular chlorinated polyethylene or polyvinyl chloride (PVC), may be employed.

In a preferred embodiment, the composition according to the present invention further comprises at least one coupling agent. It is typically an organic compound having at least one functional group capable of interacting with the hydroxyl groups present on the surface of the bauxite particles. The coupling agent may in particular be selected from: silane compounds, epoxy compounds, monocarboxylic or, preferably, bicarboxylic compounds, or derivatives thereof (preferably esters or anhydrides). The coupling agent usually includes an ethylene unsaturation, so that it can be grafted directly onto the polymeric material by addition of a radical initiator (typically an organic peroxide). The grafting reaction can preferably be carried out in an extruder (by means of the so-called “reactive extrusion”). Alternatively, the coupling agent can be pre-grafted onto at least one ethylene homopolymer or copolymer of ethylene with at least one C₃-C₁₂ alpha-olefin. This grafted polymer is then added to the base polymeric material as an additional component.

The composition in accordance with the present invention may comprise other components known in the art, such as: antioxidants, UV radiation absorbers, processing aids, lubricants, pigments, dyes, other fillers (e.g. glass particles or fibres, kaolin, talc, calcium carbonate, or mixtures thereof). High- and ultra-high molecular weight siloxane polymers can advantageously be used as processing aids.

The composition according to the present invention is preferably thermoplastic (i.e., non-crosslinked), although for some applications it may be appropriate to crosslink the composition after it has been formed.

The composition according to the present invention can be produced according to known techniques, by mixing the base polymeric material, the flame retardant filler and any other additives in a batch mixer or, preferably, in a continuous mixer. Among the batch mixers, for example, mixers equipped with tangential (Banbury) or interpenetrating rotors can be used, while the continuous mixers are preferably Buss co-kneader mixers or single-screw or double-screw extruders (counter-rotating or preferably co-rotating).

The composition according to the present invention can be used to make products of various kinds, where the presence of a polymeric material having excellent mechanical properties and high fire resistance is required. In particular, the composition according to the present invention can be used to produce cable coatings for the transport or distribution of electrical energy and/or for telecommunications, panels and coverings for buildings (for example ACP-type composite panels—Aluminium Composite Panels), pipes, and the like.

The following working examples are provided merely to illustrate the present invention and should not be construed so as to limit the scope of protection defined by the claims.

### EXAMPLES 1-3

The following flame retardant fillers have been characterised:
ATH 1 (comparative)=product obtained by re-precipitation of synthetic aluminum hydroxide by means of Bayer process (Martinal™ OL 104 LEO, produced by Huber/Martinswerk);
ATH 2 (comparative)=product obtained by grinding synthetic aluminum hydroxide by means of Bayer process (Alufy™ 2, produced by Nuova Sima);
ATH 3 (invention)=product obtained by grinding a natural bauxite with a high gibbsite content.

The chemical-physical characterization is shown in the following Table 1:

TABLE 1

| Properties | Unit of measurement | ATH 1 | ATH 2 | ATH 3 |
|---|---|---|---|---|
| Gibbsite | % by weight | 99.9 | 98.9 | 93.3 |
| content | | | | |
| d₁₀ | μm | 1.13 | 0.71 | 0.43 |
| d₅₀ | μm | 1.97 | 3.01 | 2.34 |
| d₉₀ | μm | 3.28 | 6.20 | 7.75 |
| Specific | m²/g | 4.02 | 7.07 | 7.19 |
| surface area | | | | |
| (BET) | | | | |
| Water content | % by weight | 0.18 | 0.80 | 0.31 |

### Method for Determining the Gibbsite (Aluminum Hydroxide) Content.

The ATHs were analysed using XRD (X-Ray Diffraction) technique to quantify the mineral phases present. The XRD spectrum was recorded using the Bruker D2 Phaser 2nd generation X-Ray Powder Diffractometer instrument with theta-theta goniometer equipped with a LynxEye SSD 160 solid-state detector and using Cu Kα radiation as the source. The quantitative phase analysis was calculated by modelling the entire diffraction profile (Whole Powder Pattern Fitting) using Rietveld method implemented in DIFFRAC. TOPAS program. The weight fraction of the characteristic phase was calculated in accordance with the Bish-Howard formula. For further details see the manual available at:
http://algol.fis.uc.pt/jap/TOPAS %204-2%20Users%20Manual.pdf

### Method for Determining Particle Size Distribution.

Gravity sedimentation method with X-ray absorption according to standard ISO 13317-3:2001, was used, operating using SediGraph III Plus instrument (Micromeritics) on powder aqueous suspensions obtained by mixing with magnetic stirrer 9.5 g of ATH in 80 ml of demineralised water containing 0.5% of dispersing agent (sodium hexametaphosphate).

### Method for Measuring Surface Area.

The BET method (standard ISO 9277-2010) was used. ATH samples were pre-treated in a nitrogen stream at 140° C. for 30 minutes to remove any foreign products adsorbed on the surface. The nitrogen adsorption isotherm was then carried out (at −196° C., assuming an area of 16.2 Å for the nitrogen molecule) using the Gemini VII instrument (Micromeritics).

### Method for Measuring the Water Content.

A Moisture Analyzer HE73 (Mettler-Toledo) halogen lamp thermobalance was used, at a temperature of 160° C., operating on 10 g of powder.

From the data shown in Table 1, it can be observed that ATH 2 and ATH 3 both have a very similar BET surface area and far higher than that of ATH 1. However, the d₅₀ value of ATH 3 is significantly lower than that of ATH 2 and almost similar to that of ATH 1, demonstrating the possibility of obtaining, by grinding bauxite, a better balance between powder fineness and surface area thereof.

In addition, the moisture content of ATH 3 is significantly lower than that of ATH 2 and close to the value of ATH 1. Thus, the bauxite in accordance with the invention (ATH 3), although having a BET similar to that of ATH 2 and higher than that of ATH 1, absorbs much less moisture than the product obtained by grinding a synthetic ATH without re-precipitation (ATH 2).

### EXAMPLES 4-6

The ATHs thus characterized were used to produce some mixtures, following a formulation typically applied for the production of insulations or outer covering sheaths for halogen-free low voltage cables. The formulations, in phr (per hundred rubber) are shown in the following Table 2:

TABLE 2

| | Example | | |
|---|---|---|---|
| | 3 ^{(*)} | 4 ^{(*)} | 5 |
| Greenflex ™ ML60 | 70.0 | 70.0 | 70.0 |
| Flexirene ™ CL10 | 20.0 | 20.0 | 20.0 |
| Fusabond ™ E226 | 10.0 | 10.0 | 10.0 |
| ATH 1 | 160.0 | — | — |
| ATH 2 | — | 160.0 | — |
| ATH 3 | — | — | 160.0 |
| Irganox ™ 1010 | 0.5 | 0.5 | 0.5 |
| MB 50-002 | 2.0 | 2.0 | 2.0 |

^{(*)} comparative

Greenflex™ ML60=ethylene-vinyl acetate (EVA) copolymer with 28% vinyl acetate, MFI (190° C./2.16 kg)=2.5 g/10 min, d=0.952 g/cm³ (produced by Versalis);
Flexirene™ CL10=linear low density polyethylene (LLDPE), MFI (190° C./2.16 kg)=2.5 g/10 min, d=0.918 g/cm³ (produced by Versalis);
Fusabond™ E226=linear low density polyethylene grafted with maleic anhydride (MAH-g-LLDPE), MFI (190° C./2.16 kg)=1.5 g/10 min, d=0.93 g/cm³ (produced by Dupont);
Irganox™ 1010=antioxidant, pentaerythritol tetrakis [3-[3,5-di-tert-butyl-4-hydroxyphenyl] propionate (produced by BASF);
MB 50-002=ultra-high molecular weight siloxane polymer dispersed in low density polyethylene (produced by Dow Corning) (processing aid).

The mixtures were produced using a two-cylinder laboratory open mixer (Battaggion 150×300), operating at a cylinder temperature of 170° C. and for a total mixing time of 10 min.

Table 3 shows the results of the characterisation of the mixtures:

TABLE 3

| | Unit of | | | |
|---|---|---|---|---|
| Properties | measurement | Ex. 4 ^{(*)} | Ex. 5 ^{(*)} | Ex. 6 |
| Stress at break | MPa | 13.3 | 12.8 | 11.4 |
| Elongation at | % | 200 | 115 | 187 |
| break | | | | |
| MFI @ | g/10 min | 6.1 | 3.0 | 3.8 |
| 150° C./21.6 kg | | | | |
| Water content | ppm | 625 | 1093 | 961 |

^{(*)} comparative

### Method for Measuring Mechanical Properties.

Mechanical properties of the mixtures were determined in accordance with standard CEI EN 60811-501/A1:2019 on die-cuts obtained from a mixture sheet with a thickness of about 1 mm, produced using a roll-mill operating at a temperature of 170° C.

### Method for Determining Melt Flow Index (MFI).

The melt flow index of the mixtures was measured in accordance with standard UNI EN ISO 1133-1:2012, using a weight of 21.6 kg and a temperature of 150° C.

### Method for Measuring Moisture Content of the Mixtures.

A moisture meter for plastics, called Aquatrac-3E (Brabender Messtechnik), was used, operating under vacuum at a temperature of 105° C. on 10 g of mixture.

From the above examples, it can be observed that the elongation at break of the composition according to the invention (Example 6) is significantly higher than that measured on the composition of Example 5, containing an ATH ground by means of Bayer process, and close to the value obtained for Example 4, containing a re-precipitated ATH.

In most of the (Italian and European) regulations concerning insulations and outer covering sheaths for halogen-free low voltage cables, an elongation at break not lower than 125% or not lower than 150% is required. Accordingly, the composition according to the invention is capable of meeting this requirement, as is the reference composition containing ATH obtained by re-precipitation by means of Bayer process, which however requires a very complex and highly polluting production process. The composition containing ATH 2 obtained by grinding synthetic aluminum hydroxide by means of Bayer process is not capable of providing adequate performance.

Furthermore, similarly to what was found on powders, the moisture content in the composition according to the invention is lower than that obtained for the composition of Example 5 (containing ATH 2).

### Measurement of Flame Performance of the Mixtures.

Experiments were conducted to measure the release of heat and smokes during the combustion of the mixture under controlled conditions. A cone calorimeter (Dual Cone calorimeter from Fire Testing Technology) was used operating in accordance with the standard ISO 5660-1:2015 (with an irradiation power equal to 50 kW/m²) on 100×100 mm mixture specimens having a thickness of 3 mm. These samples were obtained by compression moulding at 170° C. and 200 bar.

The parameters generally used to evaluate the fire performance of the mixtures are as follows:
Time To Ignition (TTI);
maximum peak of Heat Release Rate (HRR);
time to reach the HRR peak;
Total Heat Released during combustion (THR);
maximum peak of Smoke Production Rate (SPR);
total heat emitted during combustion (TSP, Total Smoke Production).

The results of these tests are shown in Table 4:

TABLE 4

| | Unit of | | | |
|---|---|---|---|---|
| Properties | measurement | Ex. 4 ^{(*)} | Ex. 5^{(*)} | Ex. 6 |
| TTI, Time To | sec | 67 | 69 | 73 |
| Ignition | | | | |
| HRR, Heat Release | kW/m² | 259 | 190 | 210 |
| Rate | | | | |
| Time to HRR peak | sec | 380 | 515 | 415 |
| THR, Total Heat | MJ/m² | 70 | 78 | 77 |
| Release @1200 sec | | | | |
| SPR, Smoke | m²/sec | 0.047 | 0.031 | 0.042 |
| Production Rate | | | | |
| TSP, Total Smoke | m² | 7.4 | 7.5 | 7.5 |
| Production @1200 | | | | |
| sec | | | | |

^{(*)} comparative

As it can be observed, the time required for ignition of the flame on the composition according to the invention (Example 6) is longer than that of the two comparison compositions, indicating a lower flammability of the same.

As regards all other parameters relating to heat release and smoke emission, the composition according to the invention is at an intermediate level between the two references, indicating a flame retardant and smoke reduction capacity very close to that shown by the reference composition containing the ATH obtained by re-precipitation by means of Bayer process. This was achieved despite the filler used in the composition according to the invention (ATH 3) has a significantly lower aluminum hydroxide content than that of the two reference fillers (ATH 1 and ATH 2).

### EXAMPLES 7-8

Two ground bauxites with different characteristics were compared:
ATH 4=product obtained by grinding a natural bauxite with a high gibbsite content (according to the invention);
ATH 5=product obtained by grinding a natural bauxite with a high gibbsite content having a specific surface area (BET)>10 m²/g. (for comparison—according to the teachings of U.S. Pat. No. 6,252,173).

The physical and chemical characterisation of these Bauxites is shown in Table 5:

TABLE 5

| Properties | Unit of measurement | ATH 4 | ATH 5 |
|---|---|---|---|
| Gibbsite | % by weight | 93.3 | 93.3 |
| content | | | |
| d₁₀ | μm | 0.52 | 0.23 |
| d₅₀ | μm | 2.43 | 1.72 |
| d₉₀ | μm | 8.87 | 11.72 |
| Specific | m²/g | 7.12 | 10.48 |
| surface area | | | |
| (BET) | | | |
| Water content | % by weight | 0.27 | 0.67 |

As can be seen, the high BET value of ATH 5 filler significantly increases the water content compared to ATH 4 according to the invention.

ATH 4 and ATH 5 fillers were used to produce mixtures having the same composition as shown in Table 2, namely:

TABLE 6

| | Example | |
|---|---|---|
| | 7 | 8 ^{(*)} |
| Greenflex ™ ML60 | 70.0 | 70.0 |
| Flexirene ™ CL10 | 20.0 | 20.0 |
| Fusabond ™ E226 | 10.0 | 10.0 |
| ATH 4 | 160.0 | — |
| ATH 5 | — | 160.0 |
| Irganox ™ 1010 | 0.5 | 0.5 |
| EXAMPLES 50-002 | 2.0 | 2.0 |

^{(*)} comparative

The mixtures were characterised as shown for Examples 4-6. The results are shown in Table 7:

TABLE 7

| | Unit of | | |
|---|---|---|---|
| Properties | measurement | Ex. 7 | Ex. 8 ^{(*)} |
| Stress at break | MPa | 11.7 | 10.6 |
| Elongation at | % | 160 | 85 |
| break | | | |
| MFI @ | g/10 min | 5.3 | 4.7 |
| 150° C./21.6 kg | | | |
| Water content | ppm | 790 | 962 |
| Water content | ppm | 1299 | 1758 |
| (after | | | |
| conditioning) | | | |
| Change in water | % | +64 | +83 |
| content | | | |

^{(*)} comparative

Table 7 also shows the water content measured after conditioning the mixtures for 5 days at room temperature) (20° C.), and the percentage change from the initial value.

From the above results, it can be observed that elongation at break of the composition according to the invention is significantly higher than that measured on the comparison composition. The latter does not meet the minimum requirement of the Italian and European standards referred to above.

Similarly to what was found on the powders, the moisture content in the composition according to the invention is lower than that obtained for the comparative composition, both in the measurement carried out on the freshly produced mixtures and in the measurement carried out after conditioning the mixtures in the environment at a constant temperature of 20° C., for a duration of 5 days. Furthermore, the change in moisture content over time shows, in the composition according to the invention, a slower moisture recovery than that of the comparative composition. In conclusion, ground bauxite with a BET>10 m²/g is not suitable for use in extrusion processes (such as those necessary for the production of cables), since the moisture contained therein can be released in the form of steam during the process, generating widespread porosity in the polymeric mixture and poor surface finish thereof.

1. A composition having flame retardant properties comprising a polymeric material and a bauxite as flame retardant filler dispersed in the polymeric material, wherein the bauxite has an aluminum hydroxide content of at least 50% by weight and is in the form of particles having an average size (d₅₀) not higher than 8.0 μm and a specific surface area (BET) not higher than 10.0 m²/g.

2. The composition according to claim 1, wherein the bauxite is present in the polymeric material in an amount equal to at least 100 parts by weight with respect to 100 parts by weight of polymeric material (phr).

3. The composition according to claim 1, wherein the bauxite is present in the polymeric material in an amount not higher than 280 phr.

4. The composition according to claim 1, wherein the bauxite is in the form of particles having an average size (d₅₀) not higher than 6.0 μm.

5. The composition according to claim 1, wherein the bauxite is in the form of particles having an average size (d₅₀) at least equal to 0.5 μm.

6. The composition according to claim 1, wherein the bauxite is in the form of particles having a specific surface area (BET) not higher than 9.0 m²/g.

7. The composition according to claim 1, wherein the bauxite is in the form of particles having a specific surface area (BET) at least equal to 2.0 m²/g.

8. The composition according to claim 1, wherein the bauxite has an aluminum hydroxide content of at least 70% by weight.

9. The composition according to claim 1, wherein the bauxite is in the form of particles pre-treated on the surface with a coupling agent selected from saturated or unsaturated fatty acids containing from 8 to 24 carbon atoms, or derivatives thereof.

10. The composition according to claim 1, wherein the polymeric material is a polyolefin.

11. The composition according to claim 10, wherein the polyolefin is an ethylene homopolymer or a copolymer of ethylene with a C₃-C₁₂ alpha-olefin, having a density of from 0.910 to 0.970 g/cm³.

12. The composition according to claim 10, wherein the polyolefin is a polyethylene selected from the group consisting of high density polyethylene (HDPE), medium density polyethylene (MDPE), low density polyethylene (LDPE) and linear low density polyethylene (LLDPE).

13. The composition according to claim 10, wherein the polyolefin is a very low density polyethylene (VLDPE) having a density from 0.870 to 0.910 g/cm³.

14. The composition according to claim 10, wherein the polyolefin is a copolymer of ethylene with an ester having an ethylenic unsaturation.

15. The composition according to claim 14, wherein the copolymer of ethylene with an ester having an ethylenic unsaturation is selected from ethylene-vinyl acetate (EVA) and ethylene-n-butylacrylate (EBA) copolymers.

16. The composition according to claim 10, wherein the polyolefin is an ethylene/propylene copolymer comprising from 5 to 25% by weight of ethylene and from 75 to 95% by weight of propylene.

17. The composition according to claim 10, wherein the polyolefin is a propylene homopolymer or a copolymer of propylene with an olefin comonomer selected from ethylene and an alpha-olefin other than propylene.

18. The composition according to claim 17, wherein the propylene copolymer is a heterophasic copolymer consisting of a propylene-based thermoplastic phase in which an elastomeric phase based on ethylene copolymerized with an alpha-olefin is dispersed.

19. The composition according to claim 10, wherein the polyolefin is a halogenated polyolefin.

20. The composition according to claim 1, wherein the composition further comprises a coupling agent.

21. The composition according to claim 20, wherein the coupling agent is selected from the group consisting of silane compounds, epoxy compounds, monocarboxylic compounds, dicarboxylic compounds, or derivatives thereof.

22. The composition according to claim 20, wherein the coupling agent is pre-grafted onto an ethylene homopolymer or copolymer of ethylene with a C₃-C₁₂ alpha-olefin.

23. A method of producing cable coatings for the transport or distribution of electrical energy and/or for telecommunications, panels and coverings for buildings and pipes, the method comprising applying the composition according to claim 1.
